(19) United States
(12) Patent Application Publication
(10) Pub. No.: US 2016/0081306 A1
(43) Pub. Date: Mar. 24, 2016

(54) RETRACTABLE LEASH MECHANISM WITH AUTOMATIC BRAKE

(71) Applicant: Lishinu D.O.O., Ljubljana (SI)

(72) Inventor: Rok Fikfak, Celje (SI)

(21) Appl. No.: 14/785,985

(22) PCT Filed: Feb. 7, 2014
(86) PCT No.: PCT/SI2014/000007

§ 371 Date: Oct. 21, 2015

(30) Foreign Application Priority Data
Jun. 7, 2013 (SI) P-201300149

(51) Int. Cl. A01K 27/00; B65H 75/44

(52) U.S. Cl. CPC A01K 27/004; B65H 75/4434

(57) ABSTRACT

The mechanism of the invention has a rotary element pivotably arranged in a lower part (1) of the housing onto a central shaft; on the upper part (3) of said rotary element snap elements (5) are pivotably arranged around a central transmission element (6). One ends (5b) of said snap elements (5) engage with a projection (6a) of the central transmission element (6) and their locking parts (5c) engage with an external lock (9) provided with teeth (9a) on the inner circumferential side.

The object of the invention is a mechanism arranged in a pet leash and allowing automatic locking of extraction of a rope and its stopping when the rope unwinds too rapidly. The mechanism for automatic locking/stopping of extraction of a rope/band of the invention is configured to be built into retractable (movable) leashes for pets and into similar devices. The invention belongs to class A01K27/00 of the International Patent Classification.

The technical problem successfully solved by the invention is a structural implementation of a mechanism for automatic locking/stopping of extraction of a rope/band, primarily configured to be built into retractable pet leashes to restrain animal's movement, or into similar devices, whereas the person having control over a pet does not need to press and/or hold any knob in order to lock/stop the rope/band from extracting.

Retractable dog leashes allow a pet (although in a limited way) to freely wander while still on a leash and under the owner's control. When a person desires to stop the rope or band from extending from the leash in order to prevent the pet from walking farther away or to pull him/her back, a knob needs to be pressed and/or held in known solutions.

Such solution is disclosed in WO patent document No. 2012/047623, in which the mechanism allows stopping the rope/band from extending if a knob is pressed. The knob sticks into teeth provided on the circumference of a disk with the rope/band. When the rotation of the disk is stopped, considerable force appears which can pull the leash out of the owner's hands.

A similar solution is disclosed in German patent document DE 20 2013 100 163 which has the same drawbacks as the above-described solution.

The pet leash mechanism with automatic locking of rope extraction of the invention replaces a need for use of any type of knob having an integrated mechanism for automatic locking or stopping the rope/band from extracting.

The mechanism of the invention is provided in the lower part of the housing with a rotary element arranged pivotably on a central shaft. On the upper part of the rotary element snap elements are arranged pivotably movably around a central transmission element. One end of the snap elements engages with a projection of the central transmission element and the locking parts of the snap elements engage with an external stop provided with teeth on the internal circumferential side.

The invention will be explained in more detail by way of an embodiment and through the use of the accompanying drawings in which:

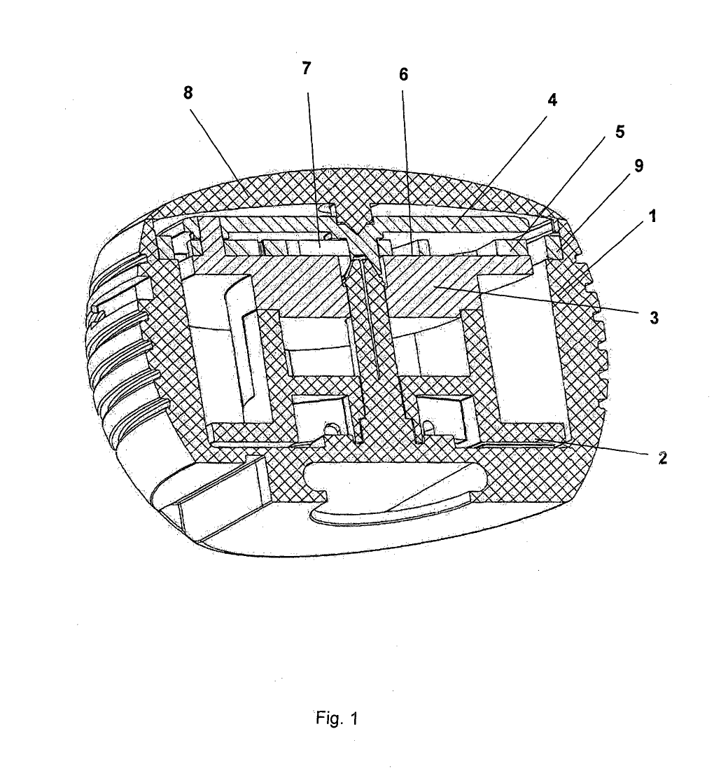

FIG. 1 illustrates a leash mechanism of the invention in axonometric view, in cross-section;

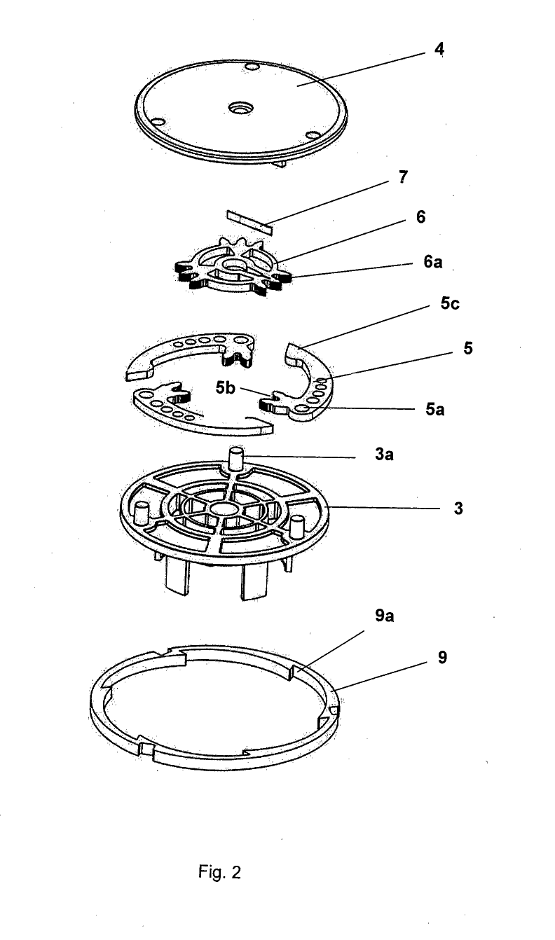

FIG. 2 illustrates main elements of the leash mechanism of the invention;

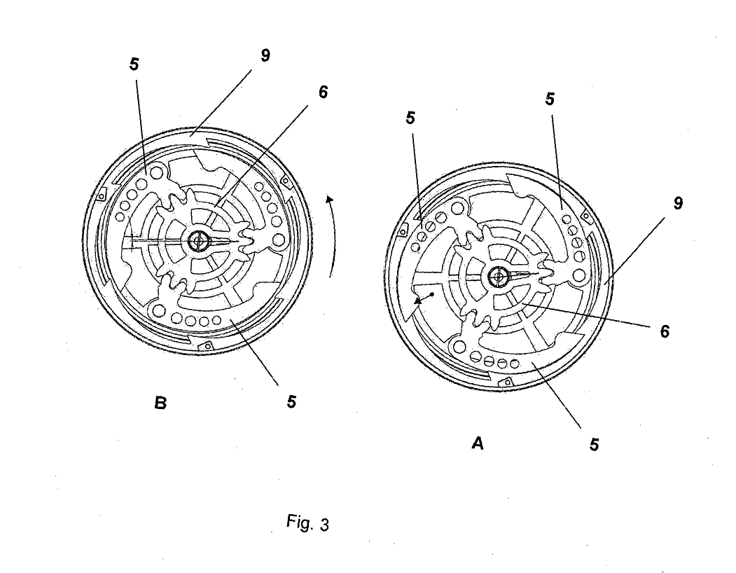

FIG. 3 illustrates the leash mechanism in a locked A and freely extending B position.

The leash mechanism of the invention in axonometric view, in cross-section, as shown in FIG. 1, consists of a lower part 1 of a housing with a central shaft, a rotary element comprised of a lower part 2 and an upper part 3, a rotary element cover 4, snap elements 5, a central transmission element 6, a spring element 7, an upper part 8 of the housing with a central shaft and an external lock 9.

In the lower part 1 of the housing a rotary element is pivotably arranged on the central shaft, said rotary element consisting of the lower part 2 and the upper part 3 as shown in FIG. 1; the rotary element can also be made of one piece. A rope/band is wound around the rotary element and ends at the bottom of the rotary element around a bulge of the central shaft on the rotary element formed by the assembled parts 2, 3 of the rotary element. On the upper part 3 of the rotary element snap elements 5 are arranged pivotably movably around the central transmission element 6 with spring elements 7, such that a recess 5a of the snap element 5 is put onto a projection 3a of the upper part 3 of the rotary element. The end 5b of the snap element 5 engages with a projection 6a of the central transmission element 6, whereas locking parts 5c of the snap element 5 engage with the external lock 9 provided on the inner circumferential side with teeth 9a. At normal speed of the rope/band, the locking parts 5c of the snap elements 5 slide along the inner edge of the lock 9, whereas, at increased speed, the locking parts 5c of the snap elements 5 get stuck due to centrifugal force into the teeth 9a arranged on the inner circumferential side of the external lock 9, thus preventing the rotary element from rotating and consequently preventing the rope/band from extracting.

FIG. 4 shows the positions of the leach mechanism in a locked and freely extractable position.

Based on described constructional characteristics, the leash mechanism of the invention uses the centrifugal force to define the limit of revolutions in order to prevent rotation. When rotation reaches the desired speed due to complete extraction of the rope/band, the locking parts 5c of the snap element 5 automatically reach into the area of the teeth 9a of the external lock 9 which prevents further rotation and extraction of the rope/band until the force is released. The force needed to act upon the locking parts 5c of the snap elements is defined by the strength of the spring element 7 (which can be replaced by a wire spring or elastic), distribution of weight of the snap elements and proximity of the locking parts 5c of the snap elements 5 to the external lock 9. These parameters are selected in relation to the needs of the device, wherein the most important parameters are a dog's weight and the rope length. The number of the snap elements (which may range from 1 to 6) is adapted to the forces that act on the mechanism of the invention and emanate especially from the weight of a dog/animal and the capacity limitation of the interior of the device. The snap elements 5 are mutually synchronized by use of the central transmission element 6.

To reach a better distribution of the force, the snap elements 5, after they hit into a barrier (tooth 9a), lean against the surface of the external locking element 9, wherewith the snap elements 5, the external locking element 9 and the rotary parts are prevented from damage. The cover 4 of the rotary element holds the snap elements 5, the central transmission element 6 and the spring element 7 firmly in place and contributes to an equal distribution of the force from the snap elements 5 over the entire surface of the upper part of the rotary element.

1. A pet leash mechanism with an automated locking of extraction of a rope integrated in retractable (movable) pet leashes and similar devices comprising:
a rotary element is pivotably arranged in a lower part (1) of the housing onto a central shaft; on the upper part (3) of said rotary element snap elements (5) are pivotably arranged around a central transmission element (6) and one ends (5b) of said snap elements (5) engage with a projection (6a) of the central transmission element (6) and their locking parts (5c) engage with an external lock (9) provided with teeth (9a) on the inner circumferential side.

2. The pet leash mechanism according to claim 1 further comprising a spring element (7) inserted in the transmission central element (6).

3. The pet leash mechanism according to claim 2 wherein the spring element (7) is a flat spring, a wire spring or elastic.

4. The pet leash mechanism according to claim 1 wherein a number of rotary element snap mechanisms (5) depends on the needed force and the capacity limitation of the interior of the device and ranges from 1 to 6.

5. The pet leash mechanism according claim 2 wherein a number of rotary element snap mechanisms (5) depends on the needed force and the capacity limitation of the interior of the device and ranges from 1 to 6.

6. The pet leash mechanism according claim 3 wherein a number of rotary element snap mechanisms (5) depends on the needed force and the capacity limitation of the interior of the device and ranges from 1 to 6.
